(19) United States
(12) Patent Application Publication
(10) Pub. No.: US 2014/0307094 A1
(43) Pub. Date: Oct. 16, 2014

(54) VEHICLE HAVING IMAGE CAPTURING SYSTEM

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/225,369

(22) Filed: Mar. 25, 2014

(30) Foreign Application Priority Data
Apr. 12, 2013 (TW) 102112947

(51) Int. Cl. B60R 1/00; H04N 7/18

(52) U.S. Cl. CPC B60R 1/00; H04N 7/18; B60R 2300/00; B60R 2300/802; B60R 2300/8046
USPC 348/148

(57) ABSTRACT

A vehicle includes a main body, a front windshield mounted on the main body, an image capturing system and a display system. The image capturing system is mounted on the main body and is configured for capturing images of the surrounding of the vehicle. The display system is adhered to the front windshield and configured for displaying the images captured by the image capturing system.

### BACKGROUND

1. Technical Field

The present disclosure relates to a vehicle.

2. Description of Related Art

A vehicle usually includes a left mirror and a right mirror. A driver can observe the surrounding of the vehicle through the left and right mirrors. Yet, when seeing the left and right mirrors, the driver must look to left or right, it is inconvenient and dangerous because the driver cannot observe the front of the vehicle when looking left and right.

Therefore, it is desirable to provide an vehicle that can overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a vehicle according to an exemplary embodiment of the present disclosure.

FIG. 2 is a schematic view showing thin film displays adhered to a front windshield of the vehicle of FIG. 1.

### DETAILED DESCRIPTION

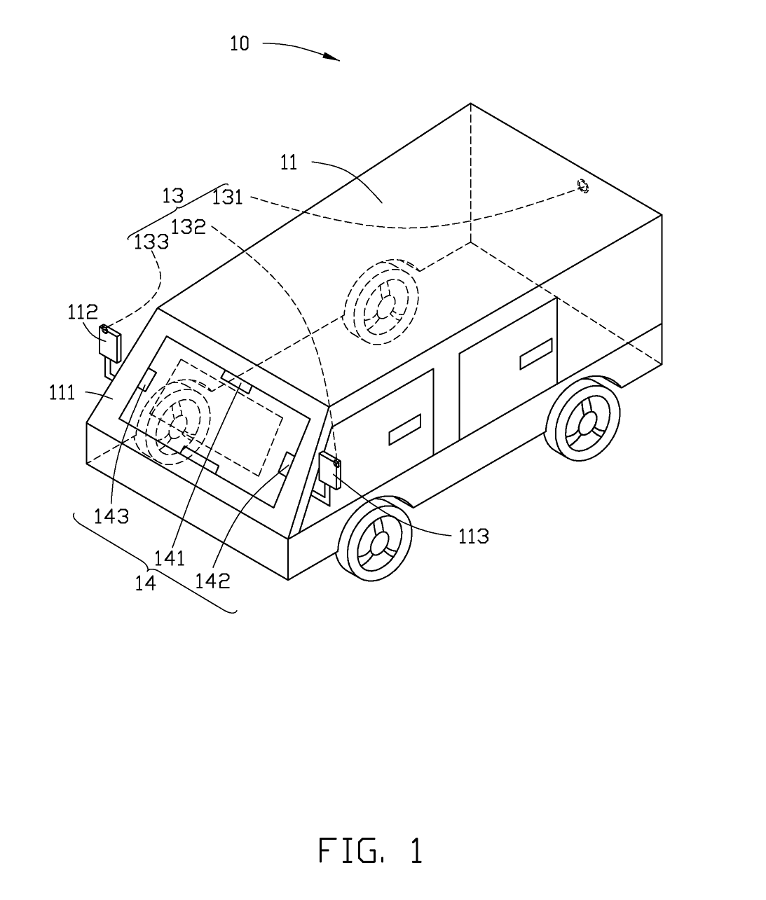

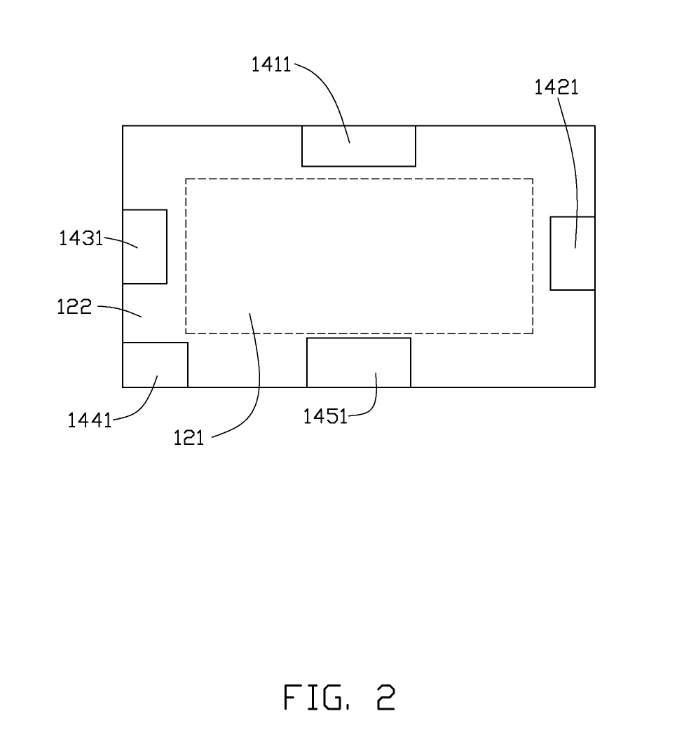

FIGS. 1 and 2 show a vehicle according to an exemplary embodiment of the present disclosure. The vehicle 10 includes a main body 11, a front windshield 12, an image capturing system 13 and a display system 14. The image capturing system 13 captures images surrounding the vehicle 10. The display system 14 is located on the front windshield 12 and displays images captured by the image capturing system 13 which are visible to the driver of the vehicle 10.

The main body 11 includes a front frame 111. The front frame 111 is a trapezoid. The front windshield 12 is mounted in the front frame 111. A right mirror 112 is mounted at a right side of the main body 11, and a left mirror 113 is mounted at a left side of the main body 11. The right mirror 112 and the left mirror 113 are rotatable relative to the main body 11.

The front windshield 12 includes an observation area 121 and a display area 122. The observation area 121 is located at a center of the front windshield 12 and the driver can observe in front of the vehicle 10 through the observation area 121. The display area 122 surrounds the observation area 121.

In this embodiment, the image capturing system 13 includes a first image capturing device 131, a second image capturing device 132 and a third image capturing device 133. The first image capturing device 131 is mounted at a backside of the main body 11 for capturing images of the backside of the vehicle 10. The second image capturing device 132 is mounted at a left side of the main body 11 for capturing images of a left and back side of the vehicle 10. The third image capturing device 133 is mounted at a right side of the main body 11 for capturing images of a right and back side of the vehicle 10. In this embodiment, the first image capturing device 131 is mounted at a middle part of a rear of the vehicle 10, the second image capturing device 132 is mounted at the left mirror 113, and the third image capturing device 133 is mounted at the right mirror 112.

The display unit 14 includes a first display device 141, a second display device 142, and a third display device 143. Each display device includes a thin film display and a processor. The processor receives the image captured by the corresponding image capturing device, processes the image, and controls the thin film display to display the image. In this embodiment, the first display device 141 includes a first thin film display 1411 and a first processor (not shown). The first thin film 1411 is adhered to the display area 122 above the observation area 121. The first thin film 1411 displays images to the rear of the vehicle 10. The second display device 142 includes a second thin film display 1421 and a second processor (not shown). The second thin film 1421 is adhered to the display area 122 adjacent to a left side of the observation area 121. The second thin film 1421 display images to the left and back of the vehicle 10. The third display device 143 includes a third thin film display 1431 and a third processor (not shown). The third thin film 1431 is adhered to the display area 122 adjacent to a right side of the observation area 121. The third thin film 1431 display images to the right and back of the vehicle 10.

The display system 14 can further includes a fourth display device and a fifth display device. The fourth display device includes a fourth thin film display 1441 for displaying dash board information and is adhered to the display area 122 adjacent to a left and bottom side of the observation area 121. The fifth display device includes a fifth thin film display 1451 for displaying navigation information and is adhered to the display area 122 adjacent to the bottom side of the observation area 121.

As the display unit can display images surrounding the vehicle, the driver does not need to turn left or right to acquire the surrounding information making driving convenient and safe.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A vehicle comprising:
a main body;
a front windshield mounted on the main body;
an image capturing system mounted on the main body and configured for capturing images of surrounding of the vehicle; and
a display system adhered to the front windshield and configured for displaying the images captured by the image capturing system.

2. The vehicle of claim 1, wherein the image capturing system comprises a plurality of image capturing devices, the display system comprises a plurality of display devices corresponding to the image capturing devices one by one, each display device comprises a thin film display for displaying images captured by the corresponding image capturing device.

3. The vehicle of claim 2, wherein the front windshield comprises an observation area located at a center of the front windshield and a display area surrounding the observation area, and the thin film display is adhered to the display area.

4. The vehicle of claim 3, wherein the image capturing system comprises a first image capturing device mounted at a rear of the main body for capturing images of the rear of the vehicle, a second image capturing device mounted at a left side of the main body for capturing images of left and back side of the vehicle, and a third image capturing device mounted at a right side of the main body for capturing images of right and back side of the vehicle.

5. The vehicle of claim 4, wherein the display system comprises a first display device, a second display device and a third display device, the first display device comprises a first thin film display above the observation area, the second display device comprises a second thin film display adjacent to a left side of the observation area, and the third display device comprises a third thin film display adjacent to a right side of the observation area.

6. The vehicle of claim 4, wherein the main body comprises a left mirror and a right mirror, the second image capturing device is mounted on the left mirror, and the third image capturing device is mounted on the right mirror.
